(19) United States
(12) Patent Application Publication
(10) Pub. No.: US 2026/0002240 A1
(43) Pub. Date: Jan. 1, 2026

(54) HIGH PERFORMANCE STAINLESS STEEL WITH RADIATION PROTECTION

(71) Applicant: AGRI IBRAHIM CECEN UNIVERSITESI IDARI VE MALI ISLER DAIRE BASKANLIGI, Agri (TR)

(72) Inventors: Abdulhalik KARABULUT, Agri (TR); Bunyamin AYGUN, Agri (TR)

(73) Assignee: AGRI IBRAHIM CECEN UNIVERSITESI IDARI VE MALI ISLER DAIRE BASKANLIGI, Agri (TR)

(21) Appl. No.: 18/881,325

(22) PCT Filed: Dec. 21, 2022
(86) PCT No.: PCT/TR2022/051562

§ 371 Date: Jan. 6, 2025

(30) Foreign Application Priority Data
Dec. 20, 2022 (TR) 2022/019812

(51) Int. Cl. C22C 30/00; G21F 1/08

(52) U.S. Cl. CPC C22C 30/00; G21F 1/085

(57) ABSTRACT

A high-performance stainless steel with radiation protection is provided. The high-performance stainless steel can be used as a shielding material against leakage of gamma and neutron radiation in nuclear power plants, boron neutron treatment units, laboratory research and investigation studies, transportation and storage of radioactive materials, and spacecraft. The high-performance stainless steel includes predetermined amount of nickel (Ni), predetermined amount of iron (Fe), predetermined amount of chromium (Cr), predetermined amount of manganese (Mn), predetermined amount of carbon (C), predetermined amount of sulfur(S), predetermined amount of silicon (Si), predetermined amount of phosphorus (P), predetermined amount of titanium (Ti), predetermined amount of tungsten (W), and predetermined amount of tantalum (Ta).

### CROSS REFERENCE TO THE RELATED APPLICATIONS

This application is the national phase entry of International Application No. PCT/TR2022/051562, filed on Dec. 21, 2022, which is based upon and claims priority to Turkish Patent Application No. 2022/019812, filed on Dec. 20, 2022, the entire contents of which are incorporated herein by reference.

### TECHNICAL FIELD

This invention relates to a high-performance stainless steel with radiation protection that can be used as a shielding material against leakage of gamma and neutron radiation in nuclear power plants, boron neutron treatment units, laboratory research and investigation studies, transportation and storage of radioactive materials, spacecraft.

### BACKGROUND

Most of the materials used in the new generation nuclear reactors in the current system are exposed to high pressure and temperatures under high-energy radiation, and it is very important that they operate smoothly under these conditions. Steels and alloys are used in many parts of nuclear reactors, especially as protectors where UO₂ fuel pellets are placed, and which prevent the mixing of fission products released as a result of fission with the cooler. However, the steels and alloys used here cause radiation leaks with deformations in their structures under high temperature and water and steam pressure, together with oxidation.

Considering the damage caused to the environment due to the toxicity of lead, which is widely used in the literature for shielding gamma rays, it comes to the fore that it should not be used. For this reason, RoHS is one of the EU directives that restricts the use of harmful substances in technology (European Commission, 2011). However, lead has low neutron absorption and causes environmental pollution.

In the research, the use of 316 LN or an alloy in large thicknesses for the armoring of a vehicle used in these areas for cleaning a debris or a piece of land contaminated with radioactive wastes that will occur as a result of a nuclear accident or war greatly reduces the working capacity of these vehicles. In order to protect the vehicles to be used in space explorations from space radiation, coating with 316 LN or a different alloy in high thickness both increases the fuel cost and reduces mobility.

In the literature, a very thick coating material should be used to protect a satellite with electronic circuits sent into space from high space radiation. This thick layer used cracks over time due to environmental effects and the radiation in the environment damages the sensitive working areas of this satellite.

“Super Alloy Preventing Radiation Leaks” is described in the patent application number TR201517729. The invention is used in nuclear power plants, boron neutron treatment units, laboratory research and investigation studies, transportation and storage of radioactive materials, space vehicles; Nickel (Ni), chromium (Cr), iron (Fe), rhenium (Re) and tungsten (W), which can be used as shielding materials against leakage of gamma radiation in the 25 MeV-7 MeV energy range and neutron radiation in the 0.4 KeV-4.5 MeV energy range It relates to the superalloy formed with substances.

In the patent application described above, a super alloy that prevents radiation leaks is mentioned. Nickel (Ni) 45-50%, iron (Fe) 10-15%, chromium (Cr) 20-25% and tungsten (W) 5-10% are used in the patent application TR201517729. The cost of stainless steel produced with this specified amount is high and its radiation absorption capacity is lower.

The patent application numbered US2009184281 describes “Method of Forming Non-Stoichiometric Nanoscale Powder Comprising Temperature-Processing Of A Stoichiometric Metal Compound”. Nanotechnology methods for creating stoichiometric and non-stoichiometric substances with unusual combination of properties by lattice level composition engineering are described. The modified properties described include electrical conductivity, dielectric constant, dielectric strength, dielectric loss, polarization, permittivity, critical current, superconductivity, piezoelectricity, mean free path, curie temperature, critical magnetic field, permeability, coercive force, magnetostriction, magnetoresistance, hall coefficient, BHmax, critical temperature, melting point, boiling point, sublimation point, phase transformation condition, vapor pressure, anisotropy, adhesion, density, hardness, ductility, elasticity, porosity, strength, toughness, surface roughness, coefficient of thermal expansion, thermal conductivity, specific heat, latent heat, refractive index, absorptivity, emissivity, dispersity, scattering, polarization, acidity, basicity, catalysis, reactivity, energy density, activation energy, free energy, entropy, frequency factor, bioactivity, biocompatibility, thermal coefficient of any property and pressure coefficient of any property.

The patent application described above describes a non-stoichiometric nanoscale powder creation method involving temperature-processing of a stoichiometric metal compound. In the patent application numbered US2009184281, metal oxides were mainly used and it was intended to produce materials with semiconductor properties. But considering the amount of elements used, it is disadvantageous in terms of cost. In addition, considering the mixing of the elements, the shelf life is short, since the product produced will be more likely to oxidize.

As a result, a new alloy with a long shelf life, low cost, which can overcome the disadvantages mentioned above, does not react with other chemicals other than the desired reactions and has a high radiation absorption capacity is needed.

### SUMMARY

This invention is a high-performance stainless steel with radiation protection, and its feature is; It is a new alloy with a long shelf life, low cost, non-reacting with other chemicals apart from the desired reactions, and high radiation absorption capacity.

The invention in order to realize all the objectives mentioned above and which will emerge from the detailed description below; It is concerned with the production of high-performance stainless steel with radiation protection feature that can be used as a shielding material against leakage of gamma and neutron radiation in nuclear power plants, boron neutron treatment units, laboratory research and investigation studies, transportation and storage of radioactive materials, spacecraft.

The invention is resistant to sulfuric acid corrosion, which has the effect of chemically corroding steels and metals, and to 15 tons of mechanical pressure, of the produced samples with a diameter of 2 cm and a thickness of 2 mm.

As a result of the experiments carried out for the subject of the invention, in the laboratory results; slow (thermal) neutrons (0.4 eV), slow (epithermal) neutrons (100 eV) medium neutrons (200 keV), fast neutrons with (4.5 MeV) energy, its absorption performance is higher than that of 316LN stainless steel, which is often used in nuclear applications and stainless-steel production is carried out using the reaction powder metallurgy mentioned below.

$$[ Ni ( \%20 ) ] + [ Fe ( \% 42 , 79 ) ] + [ Cr ( \%15 ) ] + [ Mn ( \%2 ) ] + [ C ( \%0 , 15 ) ] + [ S ( \%0 , 015 ) ] + [ Si ( \% 1 ) ] + [ P ( 0 , 045 ) ] + [ Ti ( \%1 ) ] + [ W ( \%15 ) ] + [ Ta ( \%3 ) ]$$

This invention prevents any leakage by using it in nuclear reactors with its superior properties such as the excellent radiation absorption capacity of the stainless steel, as well as its sulfuric acid corrosion, pressure and high temperature resistance, and weldability.

Considering the physical properties of the invention, when a thinner coating is made with the stainless steel in areas with radiation environment, military and space vehicles, both excellent resistance to radiation and flexibility of movement are gained.

The subject of the invention, by making a thinner coating with stainless steel on the vehicles to be used for space exploration, both the fuel cost is reduced, and the acceleration capacity of the vehicle is increased.

By making a thinner layer coating with the stainless steel introduced by the invention, the satellites are protected from harmful space radiation. In addition, safe transportation and storage of radioactive waste and radiation sources are ensured.

The elements used in the product subject to the invention at the rate of nickel (Ni) 20%, iron (Fe) 42.79%, chromium (Cr) 15% and tungsten (W) 15% differ from the ratios of the elements specified in the patent application number TR201517729, which is stated in the state of the art. The resistance of the stainless steel, which is formed as a result of the reactions with the addition of the specified elements in different proportions, differs in terms of melting point and hardness. It also provides high absorption capacity for both neutron and gamma radiation. The use of manganese (Mn), carbon (C), sulfur(S), silicon (Si), phosphorus (P), titanium (Ti) and tantalum (Ta) elements also differs in the invention.

With the product of the invention, neutron particles, which are very difficult to stop, are provided to be stopped.

The normal reinforced concrete shear wall thickness of the unit (linac) used in the application of radiotherapy treatments in this invention is approximately 2.5 m. With this stainless steel, which can be placed in the form of a plate inside this wall, this thickness can be reduced by approximately 20 cm. In addition, with the use of this stainless steel, the weight of a door, which is used in nuclear application areas and reaches up to 8 tons, can be reduced by approximately 500 Kg.

### DETAILED DESCRIPTION OF THE EMBODIMENTS

The invention contains elements of nickel (Ni) 20%, iron (Fe) 42.79%, chromium (Cr) 15%, manganese (Mn) 2%, carbon (C) 0.15%, sulfur(S) 0.015%, silicon (Si) 1%, phosphorus (P) 0.045%, titanium (Ti) 1%, tungsten (W) 15%, tantalum (Ta) 3% by weight. The alloy is obtained by mixing the specified quantities. The high-performance stainless steel with radiation protection properties of this alloy has been subjected to experiments.

A material with a high macroscopic cross-section has a high radiation absorption power at the same rate. While the macroscopic cross section of the produced sample for fast neutrons with 4.5 MeV energy, calculated according to the GEANT4 simulation program, is as high as 0.360637 cm-1 for nuclear stainless steel, the macroscopic cross section of 316LN steel for fast neutrons with 4.5 MeV energy is 0. It is 309224 cm-1 and its melting point is in the range of 1380-1450° C. For these reasons, the product subject to the invention has superior properties than 316LN steel.

The dose measurement made in the experiments was measured as 1,38556 μSv/h for neutrons with an energy velocity of 4.5 MeV. The known dose of 316LN steel used in nuclear applications known in the literature is 0.40744 μSv/h. While this known dose absorbs 29%, the nuclear stainless steel produced shows an absorption performance of 43% with an absorption dose of 0.60915 μSv/h. According to these results, this stainless-steel sample has an excellent neutron radiation retention compared to 316 LN stainless steel.

According to the GEANT4.9.2 kit of the Monte Carlo Simulation program, the linear absorption cross section of 316LN steel used against gamma radiation for gamma radiation with 1.25 MeV energy is 0.32273 cm⁻¹, and the mass absorption cross section is 4.2841 mm²/g. The linear absorption cross section of the nuclear stainless steel, the product of the invention, for gamma radiation with 1.25 MeV energy was found to be 0.49844 cm⁻¹ and the mass absorption cross section was found to be 5.3172 mm²/g. Likewise, while the linear absorption cross section of 316LN steel known in the literature for gamma radiation with 7 MeV energy is 0.235577 cm⁻¹ mass absorption cross section is known as 2.9472 mm²/g, as a result of the experiments, the stainless steel, which is the subject of the invention, has 7 MeV energy gamma radiation. The linear absorption cross section was found to be 0.29196 cm⁻¹ and the mass absorption cross section was found as 3.1146 mm²/g. According to these results, the stainless steel, which is the subject of the invention, has a superior shielding ability for gamma radiation with 1.25 MeV and 7 MeV energies. The large linear absorption coefficient in shielding application of gamma radiation indicates that the material has good shielding ability.

What is claimed is:

1. A high-performance stainless steel with a radiation protection comprising
a predetermined amount of nickel (Ni),
a predetermined amount of iron (Fe),
a predetermined amount of chromium (Cr),
a predetermined amount of manganese (Mn),
a predetermined amount of carbon (C),
a predetermined amount of sulfur(S),
a predetermined amount of silicon (Si),
a predetermined amount of phosphorus (P),
a predetermined amount of titanium (Ti),
a predetermined amount of tungsten (W), and
a predetermined amount of tantalum (Ta).

2. The high-performance stainless steel with the radiation protection according to claim 1, wherein the predetermined amount of nickel (Ni) is 20% by weight.

3. The high-performance stainless steel with the radiation protection according to claim 1, wherein the predetermined amount of iron (Fe) is 42.79% by weight.

4. The high-performance stainless steel with the radiation protection according to claim 1, wherein the predetermined amount of chromium (Cr) is 15% by weight.

5. The high-performance stainless steel with the radiation protection according to claim 1, wherein the predetermined amount of manganese (Mn) is 2% by weight.

6. The high-performance stainless steel with the radiation protection according to claim 1, wherein the predetermined amount of carbon (C) is 0.15% by weight.

7. The high-performance stainless steel with the radiation protection according to claim 1, wherein the predetermined amount of sulfur(S) is 0.015% by weight.

8. The high-performance stainless steel with the radiation protection according to claim 1, wherein the predetermined amount of silicon (Si) is 1% by weight.

9. The high-performance stainless steel with the radiation protection according to claim 1, wherein the predetermined amount of phosphorus (P) is 0.045% by weight.

10. The high-performance stainless steel with the radiation protection according to claim 1, wherein the predetermined amount of titanium (Ti) is 1% by weight.

11. The high-performance stainless steel with the radiation protection according to claim 1, wherein the predetermined amount of tungsten (W) is 15% by weight.

12. The high-performance stainless steel with the radiation protection according to claim 1, wherein the predetermined amount of tantalum (Ta) is 3% by weight.
